(19) United States
(12) Patent Application Publication
(10) Pub. No.: US 2026/0001495 A1
(43) Pub. Date: Jan. 1, 2026

(54) ROOF ARRANGEMENT WITH LINER ELEMENT

(71) Applicant: Webasto SE, Stockdorf (DE)

(72) Inventor: Guido BOTT, Stockdorf (DE)

(21) Appl. No.: 18/879,591

(22) PCT Filed: Jun. 22, 2023
(86) PCT No.: PCT/EP2023/066971

§ 371 Date: Dec. 27, 2024

(30) Foreign Application Priority Data
Jul. 8, 2022 (DE) 10 2022 117 098.5

(51) Int. Cl. B60R 13/02

(52) U.S. Cl. CPC B60R 13/0225

(57) ABSTRACT

A roof arrangement of a motor vehicle, having a fixed roof element, which is disposed rigidly and so as to not be displaceable with respect to a roof substructure and which comprises a flat glass and/or plastic panel, and a headliner with a liner element, which forms an inner visible surface and which is connected to the fixed roof element, the fixed roof element having a molded portion, which is molded to the glass and/or plastic panel. At least one retaining element is fastened to the molded portion, the retaining element having a fastening geometry, via which the liner element is fastened to the retaining element.

### CROSS-REFERENCE TO RELATED APPLICATIONS

This application is a U.S. national phase application filed under 35 U.S.C. § 371 of International Application No. PCT/EP2023/066971, filed on Jun. 22, 2023, published under WO2024/008466A1 on Jan. 11, 2024, designating the United States, which claims priority from German Patent Application Number 10 2022 117 098.5, filed on Jul. 8, 2022, which are hereby incorporated herein by reference in their entirety.

### FIELD

The invention relates to a roof arrangement of a motor vehicle having the features of the preamble of claim 1.

### BACKGROUND ART

A roof arrangement of this kind is known from practice and forms, for example, a fixed roof which is configured as a panoramic roof and which is provided with a transparent glass or plastic panel, through which ambient light can enter into an interior of the respective motor vehicle. Vehicles with fixed transparent modules (FTM) are also known.

In order to reduce the solar radiation-induced heat input into such a transparent roof element, known vehicles often have a roller blind system with a movable sun visor, which can be used to at least temporarily cover a transparent roof element from the inside.

The glass or plastic panel has a circumferential edge foam, for example, which is in particular made of a polyurethane material and which can be used for sealing against adjoining outer skin portions. Furthermore, the known roof arrangement comprises a headliner with a liner element, which forms an inner visible surface of the roof arrangement visible from the vehicle interior. To provide the inside of the roof arrangement with an aesthetically pleasing appearance, an edge of the liner element adjoins the glass or plastic panel. The fastening is effected by means of a clamp which is interlocked with a counter element, which is glued to the glass or plastic panel. Special components are required for this, which is reflected in the cost of the roof arrangement. In the state of the art, this clamp is usually fastened to frame parts and/or guide rails and/or steel or plastic frame elements and/or profile strips of a roller blind system and/or a vehicle body.

A roof arrangement, which comprises a roof panel with an edge foam, is known from document DE 101 55 170 B4, for example.

Known roller blind systems are being used less and less in modern vehicle constructions. The use of electrically switchable glazing, whose transmittance can be regulated by an electrically excited control signal, and/or by the use of low transmission of total solar energy glass is making conventional roller blind systems increasingly obsolete. In addition, the new technologies mean that a plurality of components that were previously part of a roller blind system can now be dispensed with. This allows a vehicle interior design to be streamlined and the usable interior space to be increased.

The disadvantage of this is that there are no longer any frame parts and/or guide rails and/or steel or plastic frame elements and/or profile strips available for fastening a liner element of a headliner, to which, for example, fastening clamps or the like could be fastened.

### SUMMARY

One object of the invention is to further develop a roof arrangement in such a way that the above-mentioned problem is at least partially solved and, in particular, the fastening of the liner element to the fixed roof element is simplified.

According to the invention, this object is attained by the roof arrangement having the features of claim 1.

Advantageous embodiments of the invention are the subject matter of the dependent claims. The invention relates to all combinations comprising at least two features disclosed in the description, the claims and/or the figures. It is obvious that the embodiments mentioned for the roof arrangement equivalently relate to a vehicle with a roof arrangement of this kind without being mentioned separately in its context. In particular, linguistically common rephrasing and/or an analogous replacement of respective terms within the scope of common linguistic practice, in particular the use of synonyms backed by the generally recognized linguistic literature, are of course comprised by the content of the disclosure at hand without every variation having to be expressly mentioned.

The invention proposes a roof arrangement of a motor vehicle having a fixed roof element, which is disposed rigidly and so as to not be displaceable with respect to a roof substructure and which comprises a flat glass and/or plastic panel. Furthermore, the roof arrangement has a headliner with a liner element, which forms an inner visible surface and which is connected to the fixed roof element. The fixed roof element has a molded portion, which is molded to the glass and/or plastic panel. According to the invention, at least one retaining element is fastened to the molded portion, the retaining element having a fastening geometry via which the liner element is fastened to the retaining element. Fasteners are arranged directly, in particular integrally, on the fixed roof element via the molded portion, the liner element being configured to be fixed to the fasteners by using the retaining element. The liner element only needs to be brought into engagement with the fastening geometry of the retaining element. The molded portion is preferably manufactured using a foaming process or an injection molding process, but can preferably also be integrally formed on the glass and/or plastic panel. The glass and/or plastic panel is preferably made of a glass material and/or a plastic material. The glass and/or plastic panel can be made partially of glass and partially of plastic.

The invention enables a cost-effective and functional connection of the liner element of the headliner to a glass and/or plastic panel. A transmittance of the glass and/or plastic panel can preferably be regulated via an electric control signal. The glass and/or plastic panel preferably comprises a low transmission of total solar energy glass. For example, the glass and/or plastic panel can be comprised by a fixed roof configured as a panoramic roof through which ambient light can enter into an interior of the respective motor vehicle. Alternatively, the glass and/or plastic panel can be comprised by a fixed, at least partly transparent module (FTM).

The molded portion of the roof arrangement according to the invention is preferably a glass or plastic element of the fixed roof element and/or the glass and/or plastic panel which is manufactured according to a molding process, such as a foaming process or an injection molding process, and thus molded in a corresponding cavity of a molding tool. The molding tool for manufacturing the molded portion is configured as a reaction injection molding tool, for example. A polyurethane material is preferably used for molding the molded portion. Preferably, the molded portion is foamed to the fixed roof element and/or the glass and/or plastic panel or foam-covered by a glass material or a plastic material of the fixed roof element and/or the glass and/or plastic panel.

The molded portion, which is molded on the glass and/or plastic panel, can be molded circumferentially or only in defined areas of the fixed roof element. With a circumferential molded portion, the at least one retaining element with the fastening geometry can be formed only locally and/or in sections and/or in areas or, alternatively, circumferentially.

In a specific embodiment of the roof arrangement according to the invention the liner element engages with the fastening geometry, the liner element engaging in particular with the fastening geometry.

In a preferred embodiment, the retaining element comprises a retaining clamp or is formed as the retaining clamp, which is clamped on or clipped to the molded portion. Preferably, the retaining element can comprise a retainer via which the retaining element is fastened to the molded portion. The fastening can preferably be reversibly detachable. This fastening makes it possible to attach the retaining element to the molded portion simply and cost-effectively. This also facilitates replacement and/or maintenance. The retaining clamp can preferably comprise two clamping legs which are connected to each other via at least one joint. Preferably, the two clamping legs can be spread apart to clamp the liner element at least in a clamping area between the two clamping legs. Preferably, there is a clamping force between the two clamping legs after insertion of the liner element through which the liner element is supported, in particular captively supported, by the retaining clamp. Preferably, the at least one joint can comprise a flexure bearing and/or be configured as any other known swivel joint. The clamping force can preferably be caused by a material-related internal stress and/or by at least one spring element. This can be used to create a restoring force that holds the liner element in place.

In a preferred embodiment, the retaining clamp comprises a portion preferably U-shaped in cross section via which the retaining clamp is clamped on and/or interlocked with and/or fastened to the molded portion. In principle, the cross section can also be V-shaped and/or rectangular and/or otherwise geometrically complementary to the molded portion. The molded portion and the (fastening and/or clamping) portion of the retaining clamp preferably interact according to the “plug-socket” principle. The portion of the retaining clamp preferably has at least one recess and/or a concavity and/or a locking portion. The molded portion preferably has at least one elevation and/or a protrusion and/or a locking portion and/or preferably protrudes from the glass and/or plastic panel in the direction of a vehicle interior. The molded portion preferably interacts with the portion of the retaining clamp in such a manner that it can be fastened to the molded portion.

In a preferred embodiment, the retaining element comprises at least one clawing hook and/or at least one barbed hook and/or at least one clawing mandrel, which engages in the molded portion. Alternatively or additionally, the molded portion can comprise at least one clawing hook and/or at least one barbed hook and/or at least one clawing mandrel, which engages in particular in the portion of the retaining element. In this way, the retaining element can be captively fastened to the molded portion. At least via the portion, the retaining element can alternatively or additionally engage with and/or interlock with and/or hook into the molded portion and/or at least a fastening area of the molded portion. Preferably, the molded portion and the retaining element can be captively fastened to each other via a splint pin lock.

In a preferred embodiment, the molded portion comprises a fixing groove in which a fixing area of the retaining element engages. A plane of the fixing groove is preferably aligned at least largely at a right angle, in particular with a tolerance of ±20%, relative to a main extension plane of the glass and/or plastic panel.

In a preferred embodiment, the fastening geometry is configured as a receptacle on a flank of the retaining element facing away from an edge of the glass and/or plastic panel, a fastening structure of the liner element engaging in the receptacle.

In a preferred embodiment, the molded portion is formed circumferentially in a frame-like manner. Preferably, several retaining elements are fastened to the molded portion. This allows the liner element to be fastened circumferentially. Thus, several retaining elements are circumferentially provided. Alternatively, only sections of the molded portion can be formed circumferentially in a frame-like manner.

In a preferred embodiment, the molded portion is disposed on a lower surface, in particular on a side of the glass and/or plastic panel directed towards the interior of the vehicle.

To optimize the interaction between the fastening geometry of the retaining element and the liner element, it is advantageous if the liner element has a fastening structure which engages in the fastening geometry and which is complementary to this fastening geometry. For example, the fastening structure comprises an edge beading, by means of which the edge of the liner element is thickened, which, in turn, engages in the groove, which forms the fastening geometry.

In an embodiment of the roof arrangement according to the invention that meets high design requirements, the molded portion is disposed on a lower surface of the glass and/or plastic panel.

Advantageously, the glass and/or plastic panel of the roof arrangement according to the invention also comprises an edge foam, which is preferably made of a polyurethane material. In a molding tool, the edge foam and the molded portion can be molded onto in a molding tool the glass and/or plastic panel in one manufacturing step. The molded portion can be integrally with the edge foam or be part of the edge foam. In an alternative embodiment of the roof arrangement according to the invention, at least areas of the molded portion are spaced apart from the edge foam.

The fixed roof element is glued to the roof substructure via a glue bead, for example. If there is a space between the edge foam and the molded portion, the glue bead is preferably disposed in said space. On the inner side of the roof arrangement, this area is lined with the headliner and thus not visible from the vehicle interior.

Preferably, the invention relates to a motor vehicle having at least one roof arrangement according to the invention. The motor vehicle can be a passenger car and/or a truck and/or a commercial vehicle and/or an autonomously or at least partly autonomously driving vehicle and/or a transport vehicle.

It is obvious that the embodiments and the illustrative examples described above and yet to be explained below can be formed not only individually but also in any combination without departing from the scope of the present invention. Moreover, the embodiments and illustrative examples mentioned above and yet to be discussed below equivalently or at least similarly relate to all designs of the invention without being mentioned separately.

Embodiments of the invention are schematically illustrated in the drawings and are described in an exemplary manner hereinafter.

### BRIEF DESCRIPTION OF THE DRAWINGS

FIG. 1 is a top view of a roof arrangement according to the invention;

FIG. 2 is a sectional view of the roof arrangement according to FIG. 1 along the line II-II in FIG. 1;

FIG. 3 is an enlarged sectional view of a roof arrangement according to FIG. 1;

FIG. 4 is a sectional view of another embodiment of a roof arrangement; and

FIG. 5 is an enlarged sectional view of the view shown in FIG. 4.

### DETAILED DESCRIPTION

The drawing shows a roof arrangement 10 of a motor vehicle 100 which covers an interior of the motor vehicle 100 and which is thus arranged above the seating area for vehicle occupants. The roof arrangement 10 comprises a fixed roof element 12, which is disposed rigidly and so as to not be displaceable with respect to a vehicle body and with respect to a roof substructure, and a movable lid element 14, which is part of a roof opening system and which is displaceable between a closed position closing a roof opening and an open position opening the roof opening at least party by means of displacement kinematics (not shown). In addition to the fixed roof element 12 and the lid element 14, the roof arrangement 10 comprises roof side rails 16A and 16B, which each form a bearing flange 18, particularly in the area of the fixed roof element 12, the fixed roof element 12 resting on bearing flange 18 via a glue bead 20 and being associated with a roof substructure.

Alternatively, the roof arrangement 10 can be configured without a roof opening system, in which case a fixed roof element which extends over the area of the roof arrangement 10 and which is disposed rigidly and so as to not be displaced with respect to a roof substructure is preferably provided.

To give the roof arrangement 10 a visually appealing appearance on its inside facing the vehicle interior, the roof arrangement 10 has a headliner 22 with a liner element 24 made of a stretchable fabric.

The fixed roof element 12 comprises a glass and/or plastic panel 26, which is preferably transparent or translucent or opaque and which is provided with an edge foam 28 on its circumferential edge, the edge foam 28 being molded from a polyurethane material.

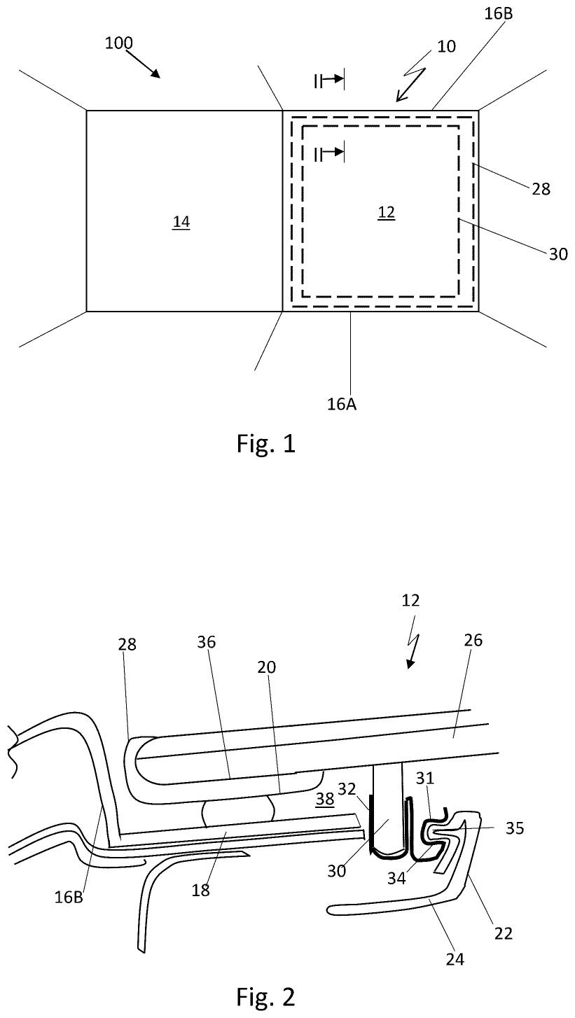

Spaced apart from the edge foam 28, the lower surface of the glass and/or plastic panel 26 has a molded portion 30, of which sections are formed circumferentially in a frame-like manner, as can be seen from dashed lines in FIG. 1, and which is molded from the polyurethane material, of which the edge foam 28 is also formed. The molded portion 30 can also be formed integrally with the glass and/or plastic panel 26.

The molded portion 30, which forms a rib projecting downwards in the direction of a vehicle interior, has a portion 32 on its side facing away from a central region or the center of the glass and/or plastic panel 26 to which a retaining element 33 is fastened, in particular clamped on and/or clamped to the portion 32. In the present case, the retaining element 33 comprises a retaining clamp 31. The retaining element 33 preferably has a fastening geometry 34, via which the liner element 24 of the headliner 22 is fastened to the retaining element 33. In the present case, portion 32 is U-shaped.

To fix the liner element 24 to the molded portion 30, it has a fastening structure 35, which is designed at least approximately corresponding to the shape of the fastening geometry 34 in the manner of an edge beading and which engages in the fastening geometry 34 of the retaining element 33 and/or is connected to it form-fittingly and/or force-fittingly. There are no other elements for fixing the liner element 24 to the fixed roof element 12 or the fastening geometry 34 of the retaining element 33.

An intermediate area 38 is located between the edge foam 28 and the molded portion 30 is, the glue bead 20, which connects the fixed roof element 12 or the glass and/or plastic panel 26 to the bearing flange 18 of the respective roof side rail 16A or 16B, being disposed in the intermediate area 38. In general, it is also conceivable that the glass and/or plastic panel 26 are integrally connected to the bearing flange 18 of the respective roof side rail 16A or 16B.

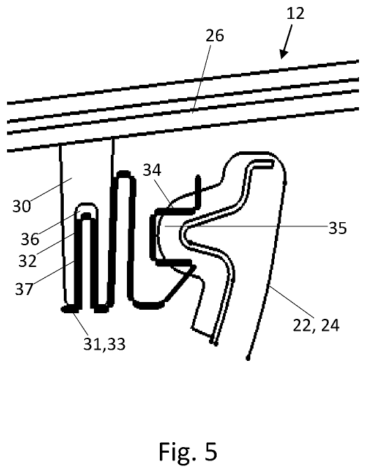

According to the FIGS. 4 and 5, in which a second illustrative example of a roof arrangement 10 according to the invention is shown, the molded portion 30 comprises a fixing groove 36, in which a fixing area 37 of the retaining element 33 engages and whose plane E1 is aligned at least largely at right angles to a main extension plane E2 of the glass and/or plastic panel 26.

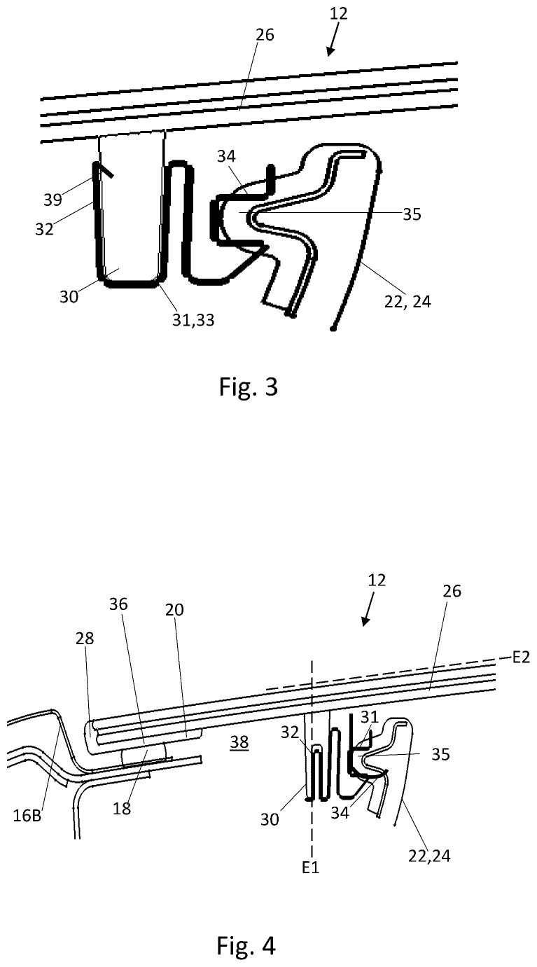

FIG. 3 schematically shows that the retaining element 33 can comprise a clawing hook and/or mandrel 39, which engages in the molded portion 30.

### REFERENCE SIGNS

10 roof arrangement
12 fixed roof element
14 lid element
16A, B roof side rail
18 bearing flange
20 glue bead
22 headliner
24 liner element
26 glass and/or plastic panel
28 edge foam
30 molded portion
31 retaining clamp
32 portion
33 retaining element
34 fastening geometry
35 fastening structure
36 fixing groove
37 fixing area
38 intermediate area
39 clawing hook and/or mandrel
100 motor vehicle
E1 plane
E2 main extension plane

1. A roof arrangement of a motor vehicle comprising:
a fixed roof element, which is disposed rigidly and so as to not be displaceable with respect to a roof substructure and which comprises a flat glass and/or plastic panel, and
a headliner with a liner element, which forms an inner visible surface and which is connected to the fixed roof element, the fixed roof element having a molded portion, which is molded to the glass and/or plastic panel,
wherein at least one retaining element is fastened to the molded portion, the retaining element having a fastening geometry via which the liner element is fastened to the retaining element.

2. The roof arrangement according to claim 1, wherein the retaining element comprises a retaining clamp or is formed as the retaining clamp, which is clamped on the molded portion.

3. The roof arrangement according to claim 2, wherein the retaining clamp comprises a portion U-shaped in cross section via which the retaining clamp is clamped on and/or interlocked with and/or fastened to the molded portion.

4. The roof arrangement according to claim 1, wherein the retaining element comprises a clawing hook and/or mandrel, which engages in the molded portion.

5. The roof arrangement according to claim 1, wherein the molded portion comprises a fixing groove in which a fixing area of the retaining element engages and whose plane is aligned at least largely at right angles to a main extension plane of the glass and/or plastic panel.

6. The roof arrangement according to claim 1, wherein the fastening geometry is configured as a receptacle on a flank of the retaining element facing away from an edge of the glass and/or plastic panel, a fastening structure of the liner element engaging in the receptacle.

7. The roof arrangement according to claim 1, wherein at least portions of the molded portion are formed circumferentially in a frame-like manner and several retaining elements are fastened to the molded portion.

8. The roof arrangement according to claim 1, wherein the molded portion is disposed on a lower surface of the glass and/or plastic panel.

9. The roof arrangement according to a claim 1, wherein the glass and/or plastic panel has an edge foam.

10. The roof arrangement according to claim 9, wherein the molded portion is formed integrally with the edge foam.

11. The roof arrangement according to claim 9, wherein the molded portion is spaced apart from to the edge foam.

12. The roof arrangement according to claim 9, wherein the glass and/or plastic panel is glued to the roof substructure via a glue bead in the area of the edge foam.

13. The roof arrangement according to claim 1, wherein the molded portion is molded from a polyurethane material.

14. A motor vehicle with at least one roof arrangement according to claim 1.
